(19) United States
(12) Patent Application Publication
(10) Pub. No.: US 2005/0160054 A1
(43) Pub. Date: Jul. 21, 2005

(54) System and method for determining postal rates

(75) Inventors: David J. Lyder SR., Winchester, CT (US); Robert H. Kummer JR., Southbury, CT (US); Linda S. Lin, Easton, CT (US); Jacques E. Hasbani, Easton, CT (US)

Correspondence Address: George M. MacDonald;Pitney Bowes Inc., 35 Waterview Drive, P.O. Box 3000, Shelton, CT, 06484, US

(73) Assignee: Pitney Bowes Incorporated, Stamford, CT (US)

(21) Appl. No.: 10/837,979

(22) Filed: May 3, 2004

Related U.S. Application Data
(60) Provisional application No. 60/481,910, filed on Jan. 16, 2004.

(51) Int. Cl. G06F 17/60

(52) U.S. Cl. 705/407; 705/401; 705/402

(57) ABSTRACT

A method and apparatus for providing rating information with respect to mailing services or other shipping services. Information regarding the weight or another characteristic of a mailpiece is provided by, e.g., weighing the mailpiece. A mailing charge for the mailpiece is displayed for a particular class of mailing or shipping service even though the user has not yet selected the class of service. A plurality of mailing charges, each for a respective class of service, is simultaneously displayed.

### CROSS-REFERENCE TO RELATED APPLICATION

This application claims the benefit under 35 U.S.C. section 119(e) of U.S. provisional patent application Ser. No. 60/481,910, filed Jan. 16, 2004 and entitled “System and Method for Determining Postal Rates”, which is incorporated herein by reference.

### BACKGROUND

This invention relates generally to the field of apparatus and methods for aiding in the mailing or shipment of letters and/or parcels, and is more particularly concerned with devices and processes for calculating mailing and/or shipping charges and presenting the calculated charges to a human operator.

Postal scales are well known. In operation of a conventional postal scale, a mailpiece is placed on the scale platform and the user of the scale navigates through a menu of mailing service classes to select a desired class of service. Upon selection of the desired class, and entry of any additional needed information, such as destination postal code (e.g., zip code), the scale calculates and displays the mailing charge for the mailpiece. According to a conventional arrangement, the postal scale may be interfaced to a postage meter to cause the meter to be set automatically to the postage amount indicated by the mailing charge for the selected class of service. The user may then operate the postage meter to print a postage indicia on the mailpiece in the denomination of the postage amount to which the meter was set.

While the conventional postal scale/postage meter arrangement can operate effectively in many cases, conventional postal scales may not be conducive to allowing the user to conveniently compare rates for different classes of service. In one conventional arrangement, for the user to be informed of the mailing charge for another class of service, he or she must de-select the original selected class and then must navigate through the menu of mailing service classes to select the other class of service that may be of interest. It is only upon completion of the second menu navigation and selection of the other class of service that the scale calculates and displays the mailing charge for the other class of service. Thus conventional postal scales may cause rate shopping among mailing classes to be inconvenient and time consuming.

### SUMMARY

Accordingly, methods and apparatus are provided for improved user convenience in considering the respective charges for various classes of mailing and/or shipping service.

In one aspect, a method of operating a mailing device is provided. The mailing device includes a first mechanism for providing mailpiece weight information (e.g., a weighing scale or a keypad via which weight information may be entered) and a second mechanism for selecting a class of mailing service from among a plurality of classes of mailing service. The method includes providing mailpiece weight information for a mailpiece, and displaying a first mailing charge for the mailpiece. The first mailing charge corresponds to a first class of mailing service that has not been selected by a user of the mailing device. Thus the mailing device may calculate a charge for a class of service and display the charge even before the user has selected that class of service, or indeed before the user has selected any class of service.

In some embodiments, the mailing device may display, simultaneously with the first mailing charge, at least a second mailing charge for the mailpiece. The second mailing charge corresponds to a class of service that may or may not have been selected by the user.

In some embodiments, the mailing device may simultaneously display a respective mailing charge for every class of mailing service for which all rating information for the mailpiece has been provided to the mailing device.

The above-mentioned first mechanism of the mailing device may be a weighing scale and the providing of the mailpiece weight information may include placing the mailpiece on the platform of the weighing scale.

The mailing device may include a housing that contains the above-mentioned first and second mechanisms and a display device on the housing. The displaying step may include displaying the first mailing charge, and possibly other mailing charges for other classes of service, on the display device. Weight information and/or other relevant information may also be simultaneously displayed with the first and/or other mailing charges.

In another aspect, a method of operating a mailing device is provided. The mailing device includes a first mechanism for providing mailpiece weight information and a second mechanism for selecting a class of mailing service from among a plurality of classes of mailing service. The method includes providing mailpiece weight information for a mailpiece, and simultaneously displaying (a) a first mailing charge for the mailpiece, corresponding to a first class of mailing service selected by a user of the mailing device, and (b) a second mailing charge for the mailpiece, corresponding to a second class of mailing service selected by the user, where the second class of service is different from the first class of service.

In still another aspect, a mailing machine includes a processor and a weighing scale coupled to the processor to provide mailpiece weight information to the processor. The mailing machine further includes a user interface coupled to the processor. The user interface includes (a) a display device for displaying information to a user of the mailing machine and (b) a mechanism for allowing the user to provide input to the processor. The mailing machine also includes a memory device coupled to the processor to store a postage rating database and for storing a program to control the processor. The processor is operative with the program to cause the display device to display to the user a first mailing charge for a mailpiece supported on the weighing scale. The first mailing charge corresponds to a first class of mailing service that has not been selected by the user. One or more additional mailing charges may simultaneously be displayed on the display device, corresponding to classes of mailing service that may or may not have been selected by the user of the mailing device. In some embodiments, the display device may simultaneously display to the user respective mailing charges for every class of mailing service for which all rating information for the mailpiece has been provided to the processor.

The mailing machine may also include a print mechanism coupled to the processor to print postage meter indicia on mailpieces, and a postal security device coupled to the processor to account for postage funds. There may also be included in the mailing machine a housing for containing and/or supporting the processor, the weighing scale, the user interface, the memory device, the print mechanism and the postal security device.

In yet another aspect, a mailing machine includes a processor and a weighing scale coupled to the processor to provide mailpiece weight information to the processor. The mailing machine further includes a user interface coupled to the processor. The user interface includes (a) a display device for displaying information to a user of the mailing machine and (b) a mechanism for allowing the user to provide input to the processor. The mailing machine also includes a memory device coupled to the processor to store a postage rating database and for storing a program to control the processor. The processor is operative with the program to cause the display device to simultaneously display to the user (a) a first mailing charge for the mailpiece that corresponds to a first class of mailing service selected by the user, and (b) a second (different) mailing charge for the mailpiece that corresponds to a second class of mailing service selected by the user. In some embodiments, more than two mailing charges (for three or more different classes of service) may be simultaneously displayed.

In still a further aspect, a method of operating a mailing device includes receiving from a user of the mailing device destination data indicative of a destination selected by the user for a mailpiece. The method further includes omitting, on the basis of the received destination data, from a menu of classes of mailing service, every class of service that is not applicable to the selected destination. The mailing device provides the menu.

In yet a further aspect, a method includes receiving information concerning at least one of the weight, the size and the dimensions of a mailpiece. The method further includes displaying to a user, in response to receiving the information, at least one shipping charge for the mailpiece without requiring the user to select a class of service for the mailpiece. This method may be performed in a device that is capable of rating shipping charges for more than one mailing and/or shipping carrier. The displayed shipping charges (if two or more are simultaneously displayed) may be for two or more carriers and/or for two or more classes of service. The receiving of the information concerning the mailpiece may include receiving weight information from a weighing scale upon which the mailpiece has been placed.

In an additional aspect, a method is provided for pre-determining postal rates using a mailing machine. The method includes receiving rating information, determining all rate-able classes of service using the rating information, and displaying a respective postage rate for each of the rate-able classes of service. The method further includes receiving a user indication of interest in a first one of the rate-able classes of service, and, in response to user input, displaying a sequence of menus of service classes with the first one of the rate-able classes of service being listed as a first item in each of the sequence of menus of service classes. The rating information may include weight information received from a weighing scale and/or destination postal code (e.g., zip code or destination country code) entered via a keypad or keyboard.

In another additional aspect, a mailing machine includes a processor and a weighing scale coupled to the processor to provide mailpiece weight information to the processor. The mailing machine further includes a user interface coupled to the processor. The user interface includes (a) a display device for displaying information to a user of the mailing machine and (b) a mechanism for allowing the user to provide input to the processor. The mailing machine also includes a memory device coupled to the processor to store a postage-rating database and for storing a program to control the processor. The processor is operative with the program to (a) receive rating information; (b) determine all rate-able classes of service using the rating information; (c) cause the display device to display a respective postage rate for each of the rate-able classes of service; (d) receive a user indication of interest in a first one of the rate-able classes of service; and (e) in response to user input, cause the display device to display a sequence of menus of service classes with the first one of the rate-able classes of service being listed as a first item in each of the sequence of menus of service classes.

As used herein and in the appended claims:
“mailpiece” refers to a letter, parcel or other item to be mailed via a postal authority (such as the U.S. Postal Service (“USPS”)) and/or shipped via a shipping carrier;
“rating information” refers to some or all of the information required to rate and/or qualify a mailpiece for a class of mailing or shipping service, and may include, e.g., (a) destination information such as a postal code or zone and/or (b) the weight and/or size and/or dimensions and/or shape of the mailpiece; and
“shipping” includes carriage of a mailpiece by a postal authority and/or by a shipping carrier.

Therefore, it should now be apparent that the invention substantially achieves all the above aspects and advantages. Additional aspects and advantages of the invention will be set forth in the description that follows, and in part will be obvious from the description, or may be learned by practice of the invention. Various features and embodiments are further described in the following figures, description and claims.

### DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIG. 1 is an isometric view of a mailing machine in which aspects of the present invention may be embodied.

FIG. 2 is a simplified block diagram representation of functional components of the mailing machine of FIG. 1.

FIG. 3 is a front view of a user interface portion of the mailing machine of FIGS. 1 and 2.

FIG. 4 schematically illustrates a USPS class of service menu structure that may be implemented in the mailing machine of FIGS. 1 and 2.

FIG. 5 is a flow diagram that illustrates a sequence of user actions and display screens that may be provided according to some aspects of the invention.

FIG. 6 is a flow chart that illustrates a process that may be performed according to some aspects of the invention.

FIG. 7 is a flow chart that illustrates a process that may be performed according to some aspects of the invention.

### DETAILED DESCRIPTION

The present invention makes it more convenient for a user of a postal scale or mailing machine to become aware of the respective charges for various classes of mailing service for a particular mailpiece that the user wishes to mail. The scale or mailing machine may display one, two or more different mailing charges, corresponding to different classes of service upon weighing the mailpiece and without requiring the user to select a particular class of service or to navigate to a final stage of a series of menus. Two or more mailing charges for different classes of service may be displayed simultaneously to help the user to compare the charges and to allow the user to select a service option accordingly.

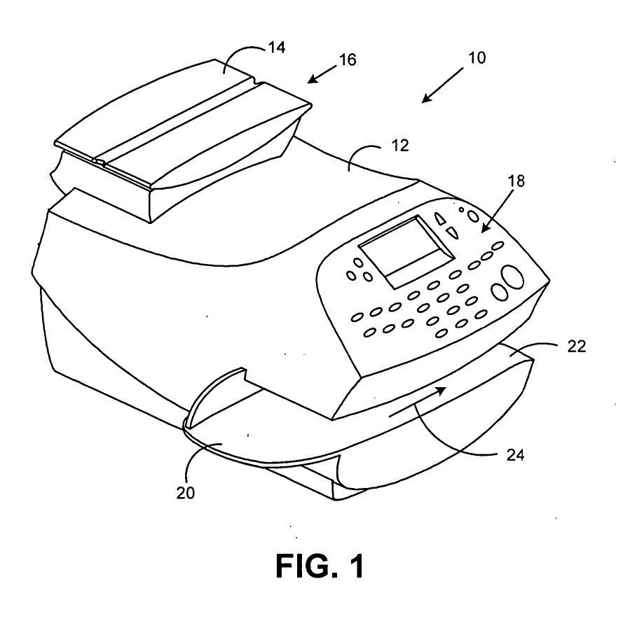

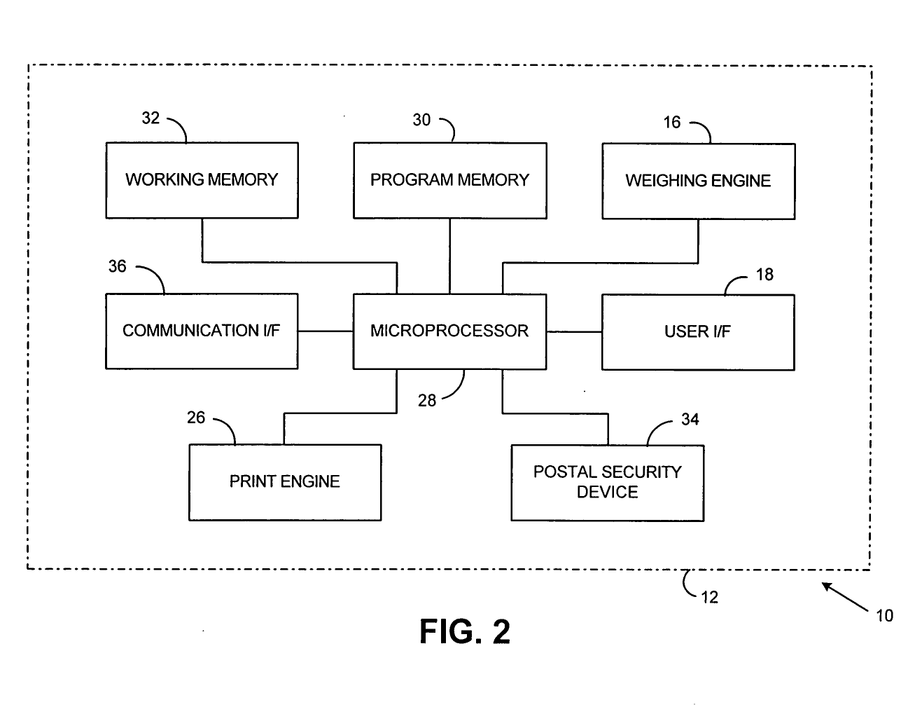

Referring now to the drawings, and particularly to FIG. 1, the reference numeral 10 indicates generally a mailing machine in which principles of the present invention may be applied. The mailing machine 10 is an integrated device in which weighing, rating, postage funds accounting, mailpiece transport and postage meter indicia printing are combined together for convenient use by the user. In particular, the mailing machine 10 includes a housing 12 which supports and/or contains all of the other components of the mailing machine 10. Located at the top rear of the housing 12 is the platform 14 of a weighing scale 16 (FIG. 2, not shown in FIG. 1 apart from the platform 14). In accordance with conventional practices, the platform 14 is configured to allow a mailpiece (not shown) to be placed thereon so that the mailpiece may be weighed by the weighing scale 16.

The mailing machine also includes a user interface 18, located at an upper front facet of the housing 12. The user interface 18 will be described in more detail below.

Extending underneath the user interface 18 and extending from the left side 20 to the right side 22 of the housing 12 is a mailpiece feed path 24. The feed path 24 allows a mailpiece (e.g., a letter) to be fed through the mailing machine 10 by a transport mechanism (not shown) past a print head (not visible in FIG. 1; represented by block 26 in FIG. 2). The print head is operable to print a postage meter indicia on the mailpiece transported through the feed path 24.

FIG. 2 is a simplified block diagram representation of functional components of the mailing machine 10. All of the components represented in FIG. 2 may be contained in and/or supported by the housing 12, which is shown in phantom in FIG. 2.

As seen from FIG. 2, the mailing machine 10 includes a microprocessor 28 which generally controls operation of the mailing machine 10. The microprocessor 28 may be mounted on a circuit board (not shown) that is contained within the housing 12.

The mailing machine 10 also includes a program memory 30 (e.g., ROM, PROM and/or flash memory) that stores software that controls the microprocessor 28 to perform various functions, including functions described hereinbelow. The program memory 30 may also store, for example, a database of postal rate information that allows the microprocessor 28 to calculate postal rates for various classes of service based on required inputs such as weight of the mailpiece and, if needed, destination information such as a zip code or country code. The program memory 30 may be mounted on the same circuit board with the microprocessor 28. In addition, working memory 32 (e.g., RAM) for the microprocessor 28 may also be mounted on the same circuit board. Both the program memory 30 and the working memory 32 are coupled to the microprocessor 28 so that data communication may occur in at least one direction between the program memory 30 or working memory 32 and the microprocessor 28.

The user interface 18 is also coupled to the microprocessor 28 to allow a user to provide input to the microprocessor 28 and to allow the microprocessor to output data in human-readable form to the user. In addition, the weighing scale 16 is coupled to the microprocessor 28 so that the weighing scale 16 is able to provide data to the microprocessor 28 that indicates the weight of a mailpiece that is supported on the scale platform 14 (FIG. 1).

Continuing to refer to FIG. 2, the mailing machine 10 also includes a postal security device 34 (PSD) that is coupled to the microprocessor 28. As is familiar to those who are skilled in the art, the PSD 34 is a tamper-resistant and/or tamper-evident device that stores and accounts for postal funds, and records register amounts that reflect events in which the mailing machine 10 is charged with postage as well as events in which postage meter indicia are printed by the mailing machine 10. For example, the PSD may be cryptographically interlocked with the microprocessor 28 to assure the postage fund balance is debited upon printing of each indicia and that printing of postage meter indicia is prevented if there is not a sufficient balance of funds remaining in the PSD.

The above-mentioned print head is part of a print engine 26 that is included in the mailing machine 10 and is coupled to the microprocessor 28 to operate under the control of the microprocessor 28 subject to constraints imposed by the PSD 34. As indicated above, the print head prints postage meter indicia on mailpieces presented to the print engine via the feed path 24 (FIG. 1). A mailpiece transport mechanism, which is not shown, may also be coupled to operate under the control of the microprocessor 28 to transport the mailpiece along the feed path and past the print head to allow printing of the indicia on the mailpiece.

Referring once more to FIG. 2, the mailing machine may further include a communication interface 36 that is coupled to the microprocessor 28 to allow the microprocessor 28 to engage in data communication with devices external to the mailing machine 10. Such communication may be conducted via a modem, which is not separately shown. For example, communication via the interface 36 may allow the PSD 34 to be recharged with postage in accordance with, e.g., the well-known “Postage By Phone”® system. Moreover, updates to the postal rate database stored in the memory 30 may be implemented by communication via the interface 36 in the event of a USPS rate change.

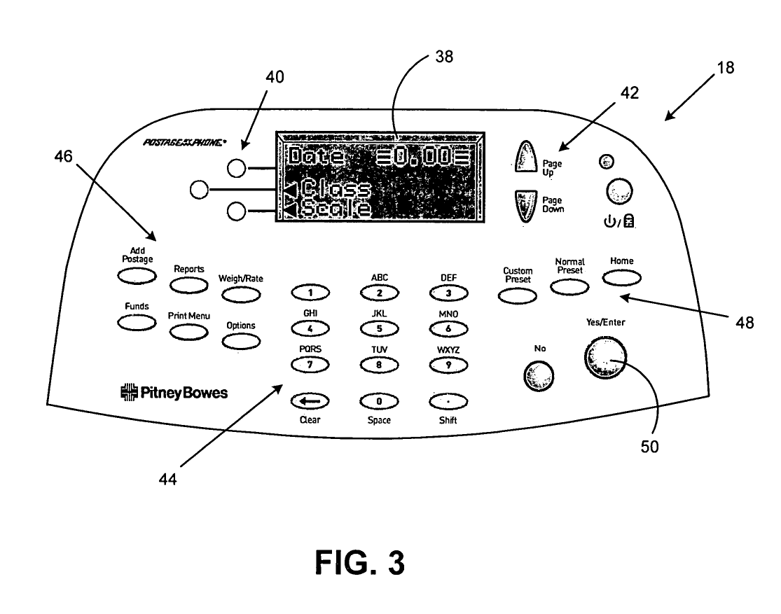

FIG. 3 presents a front view of the user interface 18.

As seen from FIG. 3, the user interface 18 includes a display device 38 by which information may be displayed in human-readable form to a user of the mailing machine 10. In some embodiments, to save on manufacturing cost and to conserve space, the display device may be a relatively small LCD display capable of displaying only a few lines of information. So-called “soft keys” 40 may be associated with the display device 38 to permit the user to select among menu items displayed on the display device 38. In other embodiments, the display device may be smaller or larger than as depicted in FIG. 3, and/or may be, or may be supplemented with, a touch screen (not shown). Scroll keys 42 may be provided to allow a user to scroll up or down through menus that can be displayed only partially at a given time on the display device 38.

It will be noted that the user interface 18 includes a number of other buttons and switches, including a numeric keypad 44, through which alphabetic characters may also be entered. Also included are various function keys 46, preset buttons 48, and an “enter” button 50. It will be appreciated that the layout, number, functions and appearances of the keys and buttons may be modified in a number of ways, in various embodiments.

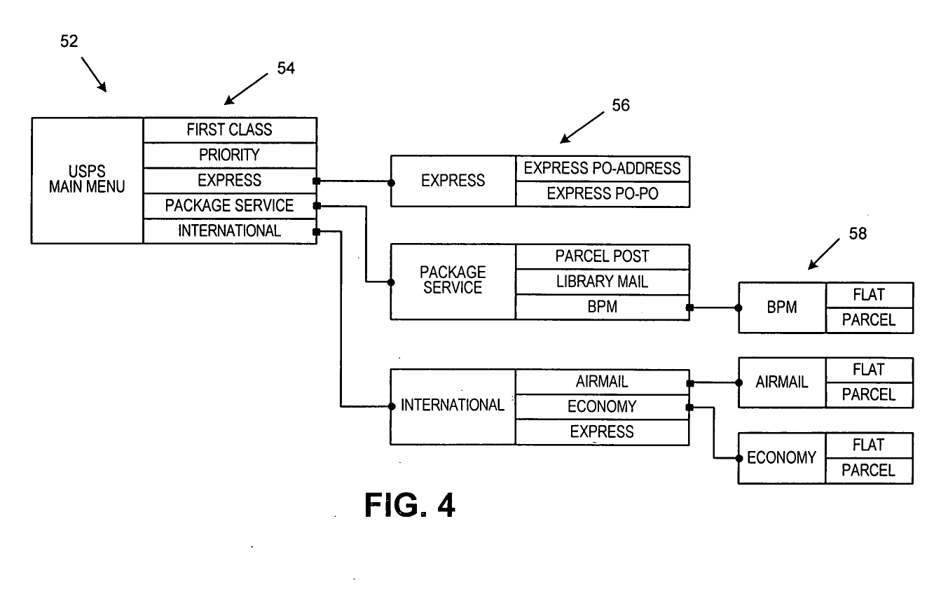

FIG. 4 schematically illustrates a USPS class of service menu structure 52 that may be implemented in the mailing machine 10. A first layer 54 of the menu structure 52 includes the “First Class” and “Priority” classes of service, as well as service category headings (which do not correspond to individual classes of service). The category headings in the first layer 54 are “Express”, “Package Service” and “International”.

In the second layer 56 of the menu structure, the “Express” category heading branches to the classes of service “Express PO-Address” and “Express PO-PO”; the “Package Service” category heading branches to the “Parcel Post” and “Library Mail” classes of service and to the “BPM” (bound printed matter) sub-category heading; and the “International” category heading branches to the “International Express” class of service and to the “Airmail” and “Economy” sub-category headings.

In the third layer 58 of the menu structure, the “BPM” sub-category heading branches to the “BPM Flat” and “BPM Parcel” classes of service; the “International Airmail” sub-category heading branches to the “International Airmail Flat” and “International Airmail Parcel” classes of service; and the “International Economy” sub-category heading branches to the “International Economy Flat” and “International Economy Parcel” classes of service.

The menu structure shown in FIG. 4 may reflect some but not all current USPS service offerings, and may be changed to reflect changes in available services and/or to present the service options to the user in different orders and/or groupings and/or to reflect decisions by the manufacturer of the mailing machine as to what menu structure may be most useful to a typical user. A quite different menu structure may be employed in a mailpiece rating device which is to be used for calculating rates for a carrier or carriers other than or in addition to the USPS.

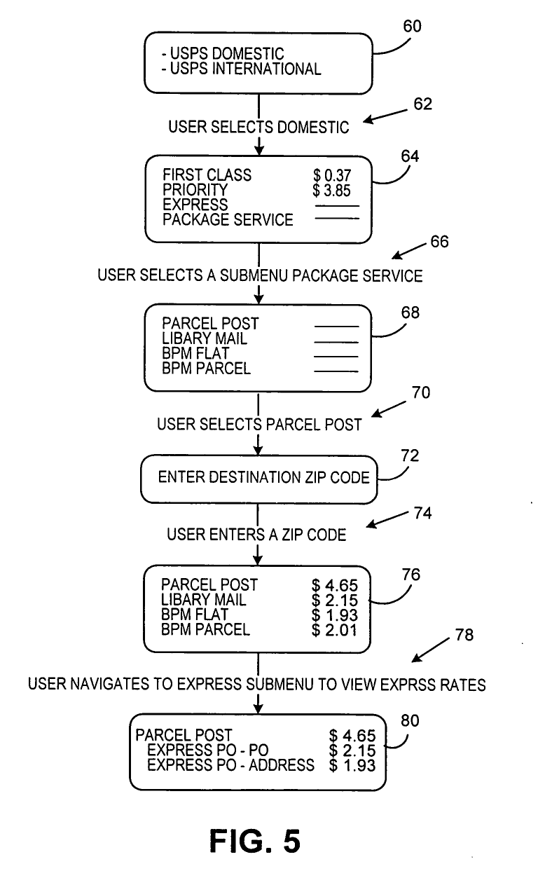

FIG. 5 is a flow diagram that illustrates a sequence of user actions and display screens that may be provided according to some aspects of the invention.

Indicated at 60 in FIG. 5 is a display screen that presents the user with two options: category headings “USPS Domestic” and “USPS International”. (It will be recognized that the menu structure implemented in FIG. 5 differs slightly from that of FIG. 3.) The screen display 60 may be displayed, for example, in response to a mailpiece being placed on the weighing scale platform.

Next, at 62, the user is assumed to select the “Domestic” category heading. It is noted that this does not constitute the selection of a class of service. In response to this action by the user, the screen 64 is displayed. The screen 64 presents the user with the following options: the “First Class” class of service, the “Priority” class of service, and the “Express” and “Package Service” subcategory headings. Also, in accordance with the invention, respective mailing charges are displayed for the “First Class” and “Priority” classes of service, even though the user has yet to select either one of these classes of service.

It is next assumed at 66 that the user selects the subcategory “Package Service”. As a result of this selection, the four constituent classes of service are displayed in the screen display 68, namely “Parcel Post”, “Library Mail”, “BPM Flat” and “BPM Parcel”. No mailing charges are now displayed for the “Parcel Post”, “BPM Flat” and “BPM Parcel” classes of service, since the rates for these classes are destination-dependent and destination information has not yet been entered into the mailing machine. However, since the rate for the “Library Mail” class of service is not destination-dependent, the mailing charge for this class is now displayed, although the class has not yet been selected. The user then selects (70) “Parcel Post” from the options available and is prompted to enter the destination zip code, which is necessary rating information, by display screen 72. The user enters the zip code at 74 and in response the display screen 76 is displayed. In the screen 76, the same four classes of service are displayed as in 68, but this time mailing charges are also displayed for each class, including the class that has been selected—“Parcel Post”—and the three classes that have not been selected.

It is next assumed, as indicated at 78, that the user wishes to see rates for the Express Mail service classes, and so navigates back through the menu to select the “Express” subheading that was first displayed at screen 64. Screen 80 results from the selection of “Express”. In screen 80 mailing charges are listed both for the “Express PO-PO” and “Express P0-Address” service classes as well as for the “Parcel Post” service class, which the user had previously selected. Indeed, the “Parcel Post” mailing charge may have been displayed in each intervening display screen (intervening screens not shown) as the user navigated from screen 76 to screen 80. Moreover, the “Parcel Post” menu item and the associated mailing charge may be the first listed item in each screen after 70, as is the case in screen 80, since the “Parcel Post” class of service is the service class in which the user has expressed interest.

From the screen 80, the user may again make a selection (say, “Parcel Post”), in which case a “home screen” (not shown) may be reached. The home screen may indicate that Parcel Post has been selected, and that the meter portion of the mailing machine 10 has been set to print an indicia in the appropriate amount (in this case $4.65). The mailpiece or a meter tape may then be inserted into the feed path 24 (FIG. 1) to activate the transport mechanism (not shown). The transport mechanism transports the mailpiece or meter tape along the feed path to the print head, which prints the postage meter indicia on the mailpiece or meter tape under the control of the microprocessor 28 (FIG. 2). At the same time, the postage fund balance in the PSD 34 is debited to reflect the postage disbursed by the printing of the postage meter indicia. Another mailpiece may now be processed by, for example, initially placing the next mailpiece on the scale platform.

Of course, the process illustrated in FIG. 5 may be varied in many ways, depending on the particular options selected by the user from each screen. Furthermore, the format and/or content of the screen displays may be changed. For example, if only a three or four line display is included in the mailing machine or scale, and/or if additional information is to be displayed in some or all screens, the menu sequence may be changed to accommodate the smaller amount of rate and class information that may be shown in each screen.

With the process exemplified in FIG. 5, a user need not navigate all the way to selection of a class of service to begin receiving displays of mailing charges for which all required rating information has been provided. Moreover, respective mailing charges for two or more classes of service may be displayed simultaneously to aid the user in determining which class of service to select. In general the process of shopping among rates is easier and more convenient for the user with the process and apparatus of the present invention.

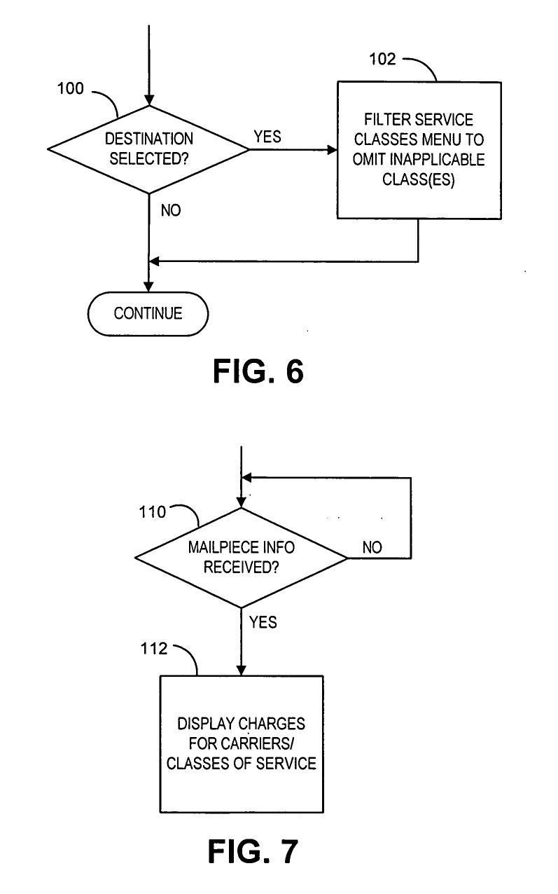

FIG. 6 is a flow chart that illustrates another process that may be performed according to some aspects of the invention. In this process, the mailing machine “filters” the menu structure to remove from the menu classes of service that are not available for a particular destination that has been selected by the user. In particular, at 100 in FIG. 6, it is determined whether the user has entered into the mailing machine destination information such as a country code. If so, and if a certain class or classes of service are not available for the selected destination, the mailing machine automatically omits the items for the inapplicable service class or classes from subsequent display screens (as indicated at 102 in FIG. 6).

FIG. 7 is a flow chart that summarizes the process illustrated in FIG. 5, as well as other processes that may be performed in accordance with the invention. At 110 in FIG. 7, it is determined whether information regarding a mailpiece is received. The mailpiece information may be mailpiece weight information provided by a weighing scale or inputted by a user via a keypad or the like. In addition or alternatively, the mailpiece information may concern one or more of the size, shape and dimensions of the mailpiece.

If a positive determination is made at 110, i.e., if the mailpiece information is received, then the apparatus may display to the user (as indicated at 112) charges for one or more classes of mailing service, without requiring the user to select a class of service. In some embodiments, the apparatus may be capable of providing rates for more than one carrier (such as the USPS as well as parcel shipping carriers such as Federal Express, United Parcel Service, DHL, Airborne Express, etc.) and the shipping charge information displayed may be for services from more than one carrier, even if some or all of the carriers have not to that point been selected by the user. Also, as discussed in connection with FIG. 5, the shipping charge information displayed may be for two or more classes of service of a single carrier, possibly including one or more classes of services that have not yet been selected by the user.

At least some of the processes disclosed herein may be performed in an integrated mailing machine such as that described above with reference to FIGS. 1-3. In addition or alternatively, at least some of the processes disclosed herein may be performed on standalone mailpiece weighing scales, standalone postage meters and/or standalone rating devices. The rating capabilities of such devices may apply to shipping services in addition to or instead of classes of service offered by a postal authority.

The words “comprise,” “comprises,” “comprising,” “include,” “including,” and “includes” when used in this specification and in the following claims are intended to specify the presence of stated features, elements, integers, components, or steps, but they do not preclude the presence or addition of one or more other features, elements, integers, components, steps, or groups thereof.

A number of embodiments of the present invention have been described. Nevertheless, it will be understood that various modifications may be made without departing from the spirit and scope of the invention. Other variations relating to implementation of the functions described herein can also be implemented. Accordingly, other embodiments are within the scope of the following claims.

1. A method of operating a mailing device that includes first means for providing mailpiece weight information and second means for selecting a class of mailing service from among a plurality of classes of mailing service, the method comprising:
providing mailpiece weight information for a mailpiece; and
displaying a first mailing charge for the mailpiece, the first mailing charge corresponding to a first class of mailing service that has not been selected by a user of the mailing device.

2. A method according to claim 1, further comprising:
contemporaneously with said displaying step, displaying a second mailing charge for the mailpiece, the second mailing charge corresponding to a second class of mailing service that has been selected by the user of the mailing device.

3. A method according to claim 1, wherein the displaying step comprises:
contemporaneously displaying a respective mailing charge for every class of mailing service for which all rating information for the mailpiece has been provided to the mailing device.

4. A method according to claim 1, wherein the first means includes a weighing scale and the providing step includes placing the mailpiece on a platform of the weighing scale.

5. A method according to claim 1, wherein:
the mailing device includes (a) a housing that contains the first and second means, and (b) a display device on the housing; and
the displaying step includes displaying the first mailing charge on the display device.

6. A method according to claim 1, further comprising:
contemporaneously with said displaying step, displaying said weight information for the mailpiece.

7. A method of operating a mailing device that includes first means for providing mailpiece weight information and second means for selecting a class of mailing service from among a plurality of classes of mailing service, the method comprising:
providing mailpiece weight information for a mailpiece; and
simultaneously displaying:
a first mailing charge for the mailpiece, the first mailing charge corresponding to a first class of mailing service selected by a user of the mailing device; and
a second mailing charge for the mailpiece, the second mailing charge corresponding to a second class of mailing service selected by the user of the mailing device, the second class being different from the first class.

8. A method according to claim 7, wherein the first means includes a weighing scale and the providing step includes placing the mailpiece on a platform of the weighing scale.

9. A method according to claim 8, wherein:
the mailing device includes (a) a housing that contains the first and second means, and (b) a display device on the housing; and
the displaying step includes displaying the first and second mailing charges on the display device.

10. A mailing machine comprising:
a processor;
a weighing scale coupled to the processor for providing mailpiece weight information to the processor;
a user interface coupled to the processor, the user interface including (a) a display device for displaying information to a user of the mailing machine and (b) means for allowing the user to provide input to the processor; and
memory means coupled to the processor for storing a postage rating database and for storing a program to control the processor;
the processor operative with the program to:
cause the display device to display to the user a first mailing charge for a mailpiece supported on the weighing scale, the first mailing charge corresponding to a first class of mailing service that has not been selected by the user.

11. A mailing machine according to claim 10, wherein the processor is further operative with the program to:
cause the display device to display, simultaneously with displaying the first mailing charge, a second mailing charge corresponding to a second class of mailing service that has been selected by the user of the mailing device.

12. A mailing machine according to claim 10, wherein the processor is operative with the program to:
cause the display device to simultaneously display to the user a respective mailing charge for every class of mailing service for which all rating information for the mailpiece has been provided to the processor.

13. A mailing machine according to claim 10, further comprising:
print means coupled to the processor for printing postage meter indicia on mailpieces.

14. A mailing machine according to claim 13, further comprising:
a postal security device coupled to the processor for accounting for postage funds.

15. A mailing machine according to claim 14, further comprising:
a housing for at least one of containing and supporting the processor, the weighing scale, the user interface, the memory means, the print means and the postal security device.

16. A mailing machine comprising:
a processor;
a weighing scale coupled to the processor for providing mailpiece weight information to the processor;
a user interface coupled to the processor, the user interface including (a) a display device for displaying information to a user of the mailing machine and (b) means for allowing the user to provide input to the processor; and
memory means coupled to the processor for storing a postage rating database and for storing a program to control the processor;
the processor operative with the program to:
cause the display device to simultaneously display to the user:
a first mailing charge for a mailpiece, the first mailing charge corresponding to a first class of mailing service selected by the user; and
a second mailing charge for the mailpiece, the second mailing charge corresponding to a second class of mailing service selected by the user, the second class being different from the first class.

17. A method of operating a mailing device, the method comprising:
receiving from a user of the mailing device destination data indicative of a destination selected by the user for a mailpiece; and
on the basis of the received destination data, omitting, from a menu of classes of mailing service, every class of mailing service that is not applicable to the selected destination, said menu provided by the mailing device.

18. A mailing machine comprising:
a processor;
a weighing scale coupled to the processor for providing mailpiece weight information to the processor;
a user interface coupled to the processor, the user interface including (a) a display device for displaying information to a user of the mailing machine and (b) means for allowing the user to provide input to the processor; and
memory means coupled to the processor for storing a postage rating database and for storing a program to control the processor;
the processor operative with the program to:
receive from the user of the mailing machine via the user interface destination data indicative of a destination selected by the user for a mailpiece; and
on the basis of the received destination data, omit, from a menu of classes of mailing service, every class of mailing service that is not applicable to the selected destination.

19. A method comprising:
receiving information concerning at least one of the weight, the size and the dimensions of a mailpiece; and
in response to receiving the information, displaying to a user at least one shipping charge for the mailpiece without requiring the user to select a class of service for the mailpiece.

20. A method according to claim 19, wherein the displaying step includes simultaneously displaying to the user a respective shipping charge for each of two or more carriers.

21. A method according to claim 19, wherein the displaying includes simultaneously displaying to the user a respective shipping charge for each of two or more classes of service.

22. A method according to claim 19, wherein the receiving step includes receiving weight information from a weighing scale.

23. A method for pre-determining postal rates using a mailing machine comprising:
receiving rating information;
determining all rate-able classes of service using the rating information;
displaying a respective postage rate for each of the all rate-able classes of service;
receiving a user indication of interest in a first one of the all rate-able classes of service; and
in response to user input, displaying a sequence of menus of service classes with the first one of the all rate-able classes of service being listed as a first item in each of the sequence of menus of service classes.

24. A method according to claim 23, wherein the rating information includes weight information received from a weighing scale.

25. A method according to claim 24, wherein the rating information includes destination postal code information entered via a keypad.

26. A mailing machine comprising:
a processor;
a weighing scale coupled to the processor for providing mailpiece weight information to the processor;
a user interface coupled to the processor, the user interface including (a) a display device for displaying information to a user of the mailing machine and (b) means for allowing the user to provide input to the processor; and
memory means coupled to the processor for storing a postage rating database and for storing a program to control the processor;
the processor operative with the program to:
receive rating information;
determine all rate-able classes of service using the rating information;
cause the display device to display a respective postage rate for each of the all rate-able classes of service;
receive a user indication of interest in a first one of the all rate-able classes of service; and
in response to user input, cause the display device to display a sequence of menus of service classes with the first one of the all rate-able classes of service being listed as a first item in each of the sequence of menus of service classes.
